(19) United States
(12) Patent Application Publication
(10) Pub. No.: US 2022/0309852 A1
(43) Pub. Date: Sep. 29, 2022

(54) SECURE DOOR LOCK HAVING SECURITY FUNCTION

(71) Applicant: ITS CO., LTD., Ulsan (KR)

(72) Inventor: Young Kyu Lee, Ulsan (KR)

(73) Assignee: ITS CO., LTD., Ulsan (KR)

(21) Appl. No.: 17/638,508

(22) PCT Filed: Jul. 14, 2020
(86) PCT No.: PCT/KR2020/009268

§ 371 Date: Feb. 25, 2022

(30) Foreign Application Priority Data
Aug. 28, 2019 (KR) 10-2019-0106172

(51) Int. Cl. G07C 9/00

(52) U.S. Cl. CPC G07C 9/00904

(57) ABSTRACT

The present invention relates to a safety door lock having a security function, which includes a digital door lock configured to determine whether to open or close a door, the safety door lock including a detection unit configured to detect any one selected from or both of the number of times the door is opened by the digital door lock and the number of times the door is attempted to be opened by the digital door lock and transmit detection information, and an output unit configured to receive the detection information transmitted from the detection unit and output the detection information to allow a user to ascertain the detection information.

### TECHNICAL FIELD

The present invention relates to a safety door lock having a security function, and more particularly, to a safety door lock having a security function, which is capable of detecting the number of times the door is opened and the number of times the door is attempted to be opened and outputting and providing the detection information through a liquid crystal display of a digital door lock, such that before a user enters his/her house, the user may recognize information as to whether an outsider has broken into or has attempted to break into the user's house on the basis of a change in the number of times of detection provided through the output unit, which makes it possible to prevent the user from suffering from damage that may occur when the user is exposed to a crime.

### BACKGROUND ART

In general, a digital door lock refers to a device configured to automatically open or close a door on the basis of information inputs such as a password input or a fingerprint input.

The digital door lock provides convenience for a user because the user need not carry a separate key. Further, the digital door lock has a higher effect of preventing an outsider from breaking into the house in comparison with a general door lock. Therefore, recently, the digital door locks are widely used to open or close the doors of the general houses or offices.

Meanwhile, recently, the number of criminal incidents, such as incidents in which thieves break into the houses or offices and steal valuables or harm people, gradually increases, which causes people to be psychologically anxious.

In particular, physically weak women, who lives alone, may be easily exposed to various types of crimes, and the women feel more fear and anxiety.

### DISCLOSURE

### Technical Problem

The present invention has been made in an effort to solve the above-mentioned problems, and an object of the present invention is to provide a safety door lock having a security function, which is capable of detecting the number of times the door is opened and the number of times the door is attempted to be opened and outputting and providing the detection information through a liquid crystal display of a digital door lock, such that a user enters his/her house, the user may recognize information as to whether an outsider has broken into or has attempted to break into the user's house on the basis of a change in the number of times of detection provided through the output unit, which makes it possible to prevent the user from suffering from damage that may occur when the user is exposed to a crime.

Another object of the present invention is to provide a safety door lock having a security function, in which a time measurement unit may measure a time zone in which the number of times the door is opened and the number of times the door is attempted to be opened are detected through a liquid crystal display of the door lock, and the detection information detected by the detection unit may be stored in the black box and used as information used to trace and arrest a criminal, thereby inducing the easy arrest of the criminal.

### Technical Solution

To achieve the above-mentioned objects, the present invention provides a safety door lock having a security function, which includes a digital door lock configured to determine whether to open or close a door, the safety door lock including a detection unit configured to detect any one selected from or both of the number of times the door is opened by the digital door lock and the number of times the door is attempted to be opened by the digital door lock and transmit detection information, and an output unit configured to receive the detection information transmitted from the detection unit and output the detection information to allow a user to ascertain the detection information.

In addition, the detection unit may detect a cumulative number by using any one selected from or both of a first method of detecting a total cumulative number by continuously and cumulatively adding the number of times of detection and a second method of setting a unit time interval and detecting the cumulative number with respect to the time by cumulatively adding only the number of times of detection for the unit time.

In addition, the safety door lock may further include a time measurement unit configured to detect a time zone in which the door is opened by the digital door lock and a time zone in which the door is attempted to be opened by the digital door lock.

In addition, the safety door lock may further include a black box configured to store and manage information detected by the detection unit and a time tracking unit.

### Advantageous Effects

The safety door lock having a security function according to the present invention described above detects the number of times the door is opened and the number of times the door is attempted to be opened and outputs and provides the detection information through the liquid crystal display of the digital door lock. Therefore, before the user enters his/her house, the user may recognize information as to whether an outsider has broken into or has attempted to break into the user's house on the basis of a change in the number of times of detection provided through the output unit. Therefore, it is possible to prevent the user from suffering from damage that may occur when the user is exposed to a crime.

In addition, the time measurement unit may measure the time zone in which the number of times the door is opened and the number of times the door is attempted to be opened are detected through the liquid crystal display of the door lock, and the detection information detected by the detection unit may be stored in the black box and used as information used to trace and arrest a criminal, thereby inducing the easy arrest of the criminal.

### DESCRIPTION OF DRAWINGS

FIG. 1 is a conceptual view of a safety door lock having a security function according to an embodiment of the present invention.

FIGS. 2 to 4 is a view for explaining the safety door lock having a security function illustrated in FIG. 1.

### BEST MODE

The technology described below may be modified in various ways and may have various embodiments, and particular embodiments illustrated in the drawings will be described in detail below. However, the description of the embodiments is not intended to limit the technology described below to the particular embodiments, but it should be understood that the technology described below is to cover all modifications, equivalents and alternatives falling within the spirit and technical scope of the technology described below.

The terms such as “first,” “second,” “A,” and “B” may be used to describe various constituent elements, but the constituent elements should not be limited by the terms, and these terms are used only to distinguish one constituent element from another constituent element. For example, a first component may be named a second component, and similarly, the second component may also be named the first component, without departing from the scope of the technology described below. The term “and/or” includes any and all combinations of a plurality of the related and listed items. For example, the words ‘A and/or B’ may include ‘A or B’, ‘A’, ‘B’, and ‘both A and B’.

It should be understood that singular expressions used in the present specification include plural expressions unless clearly described as different meanings in the context. In the present specification, it should be understood the terms “comprises,” “comprising,” “includes,” “including,” “containing,” “has,” “having” or other variations thereof are inclusive and therefore specify the presence of stated features, numbers, steps, operations, elements, components, or combinations thereof, but do not preclude the presence or addition of one or more other features, numbers, steps, operations, elements, components, or combinations thereof.

Prior to the detailed description of the drawings, it is intended to clarify that the classification of the configuration portions in this specification is merely classified by a main function that each configuration portion is responsible for. That is, two or more configuration portions to be described below may be combined into one configuration portion, or one configuration portion may be classified into two or more configuration portions according to more subclassified functions. In addition, each of the configuration portions to be described below may additionally perform some or all of the functions of other configuration portions in addition to its own main function, and it goes without saying that some of the main functions of each configuration portion may be performed exclusively by another configuration portion.

In addition, in performing a method or an operation method, each of steps constituting the method may be performed differently from the specified order unless a specific order is clearly stated in the context. That is, each of the steps may be performed in the same order as specified, may be performed substantially simultaneously, or may be performed in the reverse order.

A safety door lock having a security function according to an exemplary embodiment of the present invention will be described below in detail with reference to the accompanying drawings. Descriptions of publicly known related functions or configurations will be omitted when it is determined that the specific descriptions may unnecessarily obscure the subject matter of the present invention.

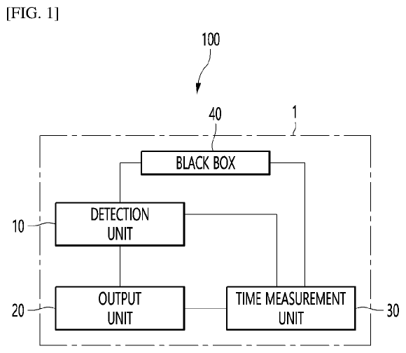

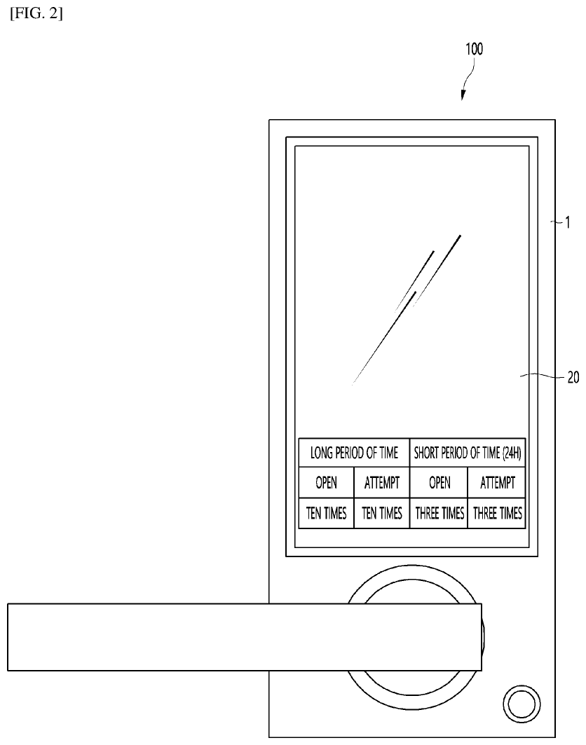

FIGS. 1 to 4 are views illustrating the safety door lock having a security function according to the embodiment of the present invention, FIG. 1 is a conceptual view of the safety door lock having a security function according to the embodiment of the present invention, and FIGS. 2 to 4 are views for explaining the safety door lock having a security function illustrated in FIG. 1.

As illustrated in the drawings, a safety door lock 100 having a security function according to an embodiment of the present invention includes a digital door lock 1 configured to determine whether to open or close a door and further includes a detection unit 10 and an output unit 20.

As illustrated in FIG. 1, the detection unit 10 detects any one selected from or both of the number of times the door is opened by the digital door lock 1 and the number of times the door is attempted to be opened by the digital door lock 1. The detection unit 10 transmits detection information to the output unit 20 to be described below.

In this case, the detection unit 10 is configured to detect both the number of times the door is opened by the digital door lock and the number of times the door is attempted to be opened by the digital door lock, but the detection unit 10 may be configured to detect only any one of the number of times the door is opened by the digital door lock and the number of times the door is attempted to be opened by the digital door lock.

In addition, as illustrated in FIGS. 2 to 4, the detection unit 10 may detect a cumulative number by using any one selected from or both of a first method of detecting a total cumulative number by continuously and cumulatively adding the number of times of detection and a second method of setting a unit time interval and detecting the cumulative number with respect to the time by cumulatively adding only the number of times of detection for the unit time.

The detection unit 10 of the safety door lock 100 having a security function according to the present invention detects the total cumulative number and the cumulative number with respect to the time by applying both the first method and the second method and provides the detection information to a user through the output unit 20. However, the present invention is of course not limited to this method to detect the cumulative number.

In this case, the first method of the detection unit 10 may cumulatively detect both the number of times the door is opened by the digital door lock 1 and the number of times the door is attempted to be opened by the digital door lock 1, thereby allowing the user to ascertain the total cumulative number for a long period of time. The second method of the detection unit 10 may allow the user to ascertain the total cumulative number for a short period of time (preset unit time).

For example, when the unit time interval is set to be 24 hours (one day) according to the second method of the detection unit 10, the detection unit 10 detects the cumulative number with respect to the time by cumulatively detecting the number of times the door is opened by the digital door lock 1 and the number of times the door is attempted to be opened by the digital door lock 1 for 24 hours.

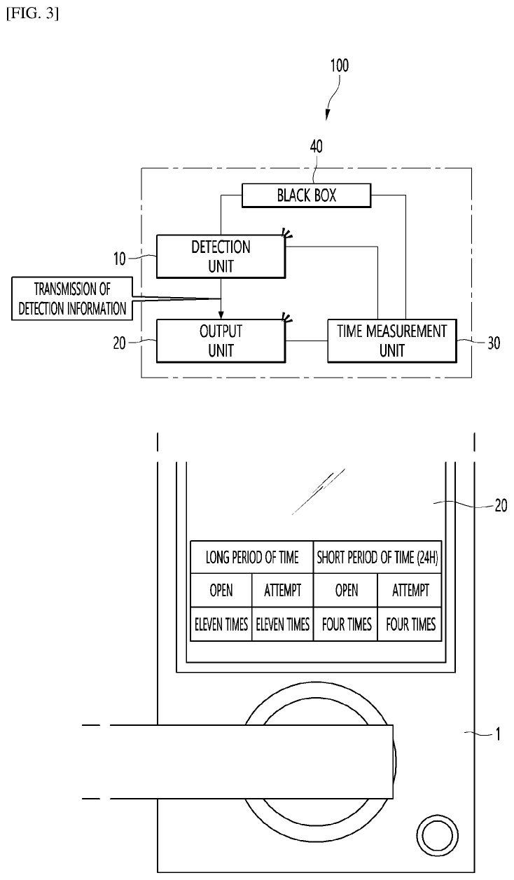

That is, as illustrated in FIG. 2, when the door is opened by the digital door lock 1 in a state in which the number of times the door is opened by the digital door lock 1 is 3 and the number of times the door is attempted to be opened is 3 within the unit time interval, the number of times the door is opened is increased by 1 and the number of times the door is attempted to be opened is increased by 1, as illustrated in FIG. 3, such that the number of times the door is opened becomes 4 and the number of times the door is attempted to be opened becomes 4. In this state, when the door is attempted to be opened by the digital door lock 1 but the door is not opened, the number of times the door is opened is maintained as 4 and the number of times the door is attempted to be opened is increased by 1 and becomes 5.

As illustrated in FIGS. 1 to 4, the output unit 20 receives the detection information transmitted from the detection unit 10 and outputs the detection information so that the user may ascertain the detection information.

In this case, the output unit 20 may be configured as a liquid crystal display configured to output an image so that the user may easily ascertain the information. In the case in which the digital door lock 1 has the liquid crystal display, the liquid crystal display of the digital door lock 1 may be used as the output unit 20.

Meanwhile, as illustrated in FIG. 1, the safety door lock 100 further includes a time measurement unit 30 configured to detect a time zone in which the door is opened by the digital door lock 1 and a time zone in which the door is attempted to be opened by the digital door lock 1.

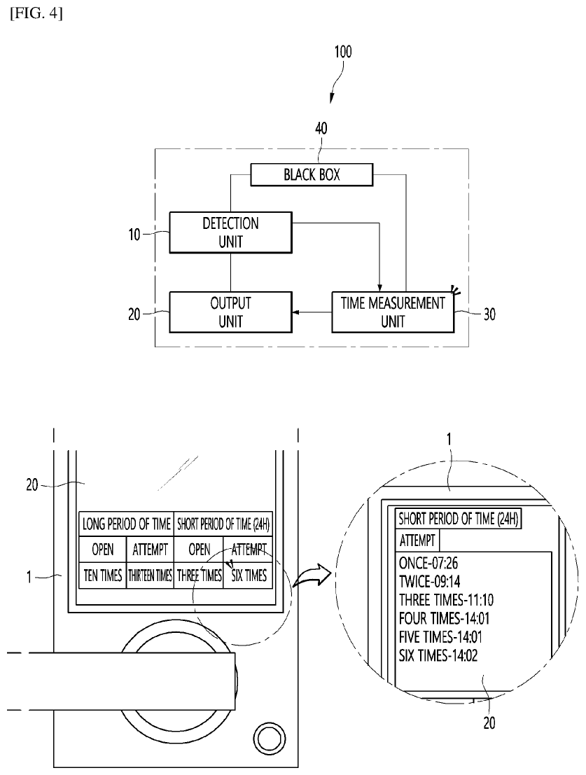

That is, as illustrated in FIG. 4, the time measurement unit 30 detects the time zone in which the door is opened and the time zone in which the door is attempted to be opened by the digital door lock 1. The detection information, which is detected as described above, is transmitted to the output unit 20 so that the user may easily ascertain the detection information.

In this case, the detection information detected by the time measurement unit 30 may be matched with the detection information detected by the detection unit 10 and then outputted through the output unit 20, thereby allowing the user to clearly recognize and ascertain the time zone with respect to the number of times of cumulative detection by the detector 10.

For example, when the door is opened by the digital door lock 1 after the door is attempted to be opened, the detection unit 10 detects that the number of times the door is opened is 1 and detects that the number of times the door is attempted to be opened is 1. In this case, the time measurement unit 30 detects the time for which the number of times the door is opened is counted as 1 and the time for which the number of times the door is attempted to be opened is counted as 1. The detection information, which is detected as described above, is matched with the output unit 20 and then outputted.

Therefore, the user may clearly recognize and ascertain the time zone at a point in time at which the door is once and the time zone in which the door is attempted to be opened once on the basis of the image outputted through the output unit 20.

Meanwhile, as illustrated in FIG. 1, the safety door lock 100 further includes a black box 40 configured to store and manage information detected by the detection unit 10 and the time tracking unit 30.

In this case, the detection information stored in the black box 40 may be used as information used to trace and arrest a criminal in the event of a criminal incident.

The safety door lock 100 having a security function according to the present invention, which has the above-mentioned components, detects the number of times the door is opened and the number of times the door is attempted to be opened and outputs and provides the detection information through the liquid crystal display of the digital door lock 1. Therefore, before the user enters his/her house, the user may recognize information as to whether an outsider has broken into or has attempted to break into the user's house on the basis of a change in the number of times of detection provided through the output unit 30 (liquid crystal display). Therefore, it is possible to prevent the user from suffering from damage that may occur when the user is exposed to a crime.

In addition, the time measurement unit 30 may measure the time zone in which the number of times the door is opened and the number of times the door is attempted to be opened are detected through the liquid crystal display of the digital door lock 1, and the detection information detected by the detection unit 10 may be stored in the black box 40 and used as information used to trace and arrest a criminal, thereby inducing the easy arrest of the criminal.

The safety door lock 100 having a security function according to the embodiment of the present invention configured as described above is installed in the house and operates as described below.

In this case, the detection unit 10 of the safety door lock 100 having a security function according to the present invention detects the number of times the door is opened and the number of times the door is attempted to be opened by using both the first and second methods. For the convenience of description, the first method will be described as being a long period of time and the second method will be described as being a short period of time. In this case, the unit time interval is set as 24 hours.

First, as illustrated in FIG. 2, the user, who intends to go out of the house, checks the information outputted through the output unit 20 of the safety door lock 100 having a security function according to the present invention. When the information indicating that the number of times the door is opened is 10 and the number of times the door is attempted to be opened is 10 is outputted as long-period information and the information indicating that the number of times the door is opened is 3 and the number of times the door is attempted to be opened is 3 is outputted as short-period information, the user checks the information and goes out.

Thereafter, as illustrated in FIG. 3, the user, who is out of the house, returns back to the house and checks the output unit of the safety door lock 100 having a security function according to the present invention. When the information indicating that the number of times the door is opened is 11 and the number of times the door is attempted to be opened is 11 is outputted as the long-period information from the output unit 20 and the information indicating that the number of times the door is opened is 4 and the number of times the door is attempted to be opened is 4 is outputted as the short-period information even though there is no one who enters the house, the user determines that someone has broken into the house, Therefore, the user asks the peripheral police officers for help, identifies the person who has broken into the house, and safely enters the house.

In addition, as illustrated in FIG. 4, the user, who is out of the house, returns back to the house and checks the output unit of the safety door lock 100 having a security function according to the present invention. When the information indicating that the number of times the door is opened is 10 and the number of times the door is attempted to be opened is 13 is outputted as the long-period information from the output unit 20 and the information indicating that the number of times the door is opened is 3 and the number of times the door is attempted to be opened is 6 is outputted as the short-period information even though there is no one who enters the house, the user determines that someone has attempted to enter the house three times by manipulating the digital door lock 1.

In this case, the time measurement unit 30 measures and provides the time information indicating the result of counting the number of times someone has attempted to open the door by manipulating the digital door lock 1 to enter the house. The user asks the peripheral police officers for help so that the police officers collect image information from the surrounding CCTVs and black boxes of vehicles when the time information has been measured. Therefore, the police officers may easily arrest the person who has attempted to enter the user's house. Therefore, it is possible to prevent criminal incidents such as stolen and robbery, which frequently occur these days, and prevent damage caused by the criminal incidents.

Accordingly, the user, who uses the safety door lock 100 having a security function according to the present invention, may safely and comfortably return to the house.

While the present invention has been described with reference to the embodiments illustrated in the accompanying drawing, the embodiments are described just for illustration, the present invention is not limited to the embodiments, and those skilled in the art will understand that various modifications of the embodiments and any other embodiment equivalent thereto are available. In addition, the present invention may be modified by those skilled in the art without departing from the spirit of the present invention. Accordingly, the scope of the present invention is not limited to the scope of the detailed description but should be determined by the appended claims and the technical spirit of the claims.

The embodiment according to the present invention may be implemented by various means, for example, hardware, firmware, software, or a combination thereof. For implementation by hardware, an embodiment of the present invention may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like.

In addition, in case of implementation by firmware or software, an embodiment of the present invention is implemented in the form of a module, procedure, function, etc. that performs the functions or operations described above and may be recorded in a readable recording medium through various computer means. Here, the recording medium may include program instructions, data files, data structures, or the like, alone or in combination. The program instructions recorded in the recording medium may be specially designed and configured for the present invention or may be known and available to those skilled in computer software. For example, the recording medium includes magnetic mediums such as hard disks, floppy disks, and magnetic tapes, optical mediums such as compact disk read only memory (CD-ROM) or digital video disk (DVD), magneto-optical mediums such as floptical disks, and a hardware device specially configured to store and execute program instructions such as ROM, RAM, flash memory, and the like. Examples of program instructions may include high-level language codes that may be executed by a computer using an interpreter, etc., as well as machine language codes made by a compiler. Such hardware devices may be configured to operate as one or more software modules to perform the operation of the present invention, and vice versa.

In addition, a device or terminal according to the present invention may be driven by instructions that cause one or more processors to perform the functions and processes described above. For example, such instructions may include interpreted instructions such as script instructions such as JavaScript or ECMAScript instructions, executable codes, or other instructions stored in a computer-readable medium. Furthermore, the device according to the present invention may be implemented in a distributed manner over a network such as a server farm or may be implemented in a single computer device.

In addition, a computer program (also known as a program, software, software application, script, or code) mounted on a device according to the present invention and executing the method according to the present invention may be created in any form of programming language including a compiled or interpreted language and a priori or procedural language and may be developed in any form including standalone programs or modules, components, subroutines, or other units suitable for use in a computer environment. The computer programs do not necessarily correspond to files in a file system. The program may be stored in a single file provided in a requested program, in multiple interactive files (e.g., files storing one or more modules, subprograms or part of codes), or in part of a file retaining other programs or data (e.g., one or more scripts stored within a markup language document). The computer programs may be arranged to be executed in one computer or in multiple computers that are located at one site or distributed across multiple sites and interconnected by a communication network.

While the drawings have been described separately for convenience of description, it is possible to design a new embodiment by combining the embodiments described in the respective drawings. In addition, the present invention is not limited by the configurations and methods of the embodiments as described above, but the embodiments may also be configured by selectively combining a whole or part of the embodiments, such that various modifications can be made.

While the exemplary embodiments have been illustrated and described above, the present specification is not limited to the specific embodiments, and various modifications can of course be made by those skilled in the art to which the present specification pertains without departing from the subject matter claimed in the claims. Further, the modifications should not be appreciated individually from the technical spirit or prospect of the present specification.

### INDUSTRIAL APPLICABILITY

The present invention may be applied in various ways to the technical field related to the door lock.

1. A safety door lock having a security function, which comprises a digital door lock configured to determine whether to open or close a door, the safety door lock comprising:
a detection unit configured to detect any one selected from or both of the number of times the door is opened by the digital door lock and the number of times the door is attempted to be opened by the digital door lock and transmit detection information; and
an output unit configured to receive the detection information transmitted from the detection unit 10 and output the detection information to allow a user to ascertain the detection information.

2. The safety door lock of claim 1, wherein the detection unit detects a cumulative number by using any one selected from or both of a first method of detecting a total cumulative number by continuously and cumulatively adding the number of times of detection and a second method of setting a unit time interval and detecting the cumulative number with respect to the time by cumulatively adding only the number of times of detection for the unit time.

3. The safety door lock of claim 1, further comprising:
a time measurement unit configured to detect a time zone in which the door is opened by the digital door lock and a time zone in which the door is attempted to be opened by the digital door lock.

4. The safety door lock of claim 3, further comprising:
a black box configured to store and manage information detected by the detection unit and the time tracking unit.
